(19) United States
(12) Patent Application Publication
(10) Pub. No.: US 2009/0083136 A1
(43) Pub. Date: Mar. 26, 2009

(54) CONSOLIDATING ONLINE PURCHASE TRANSACTIONS

(76) Inventor: Scott Kyle Blackwood, Devonport (NZ)

Correspondence Address: HARNESS, DICKEY, & PIERCE, P.L.C, 7700 Bonhomme, Suite 400, ST. LOUIS, MO, 63105, US

(21) Appl. No.: 11/859,712

(22) Filed: Sep. 21, 2007

(51) Int. Cl. G06Q 30/00

(52) U.S. Cl. 705/14; 705/26; 705/37

(57) ABSTRACT

A system for providing an online marketplace for buyers and suppliers. A processor and memory are configured to establish a buying community as a portal on a network and associate the community with buyers and suppliers. The processor and memory provide for cooperation, by the buyers and/or suppliers, in buy and/or supply relationships with buyers and/or suppliers associated with another buying community established on the network.

### FIELD

The present disclosure relates to a system for associating buyers with sellers through buying communities for commercial transactions via a communications network.

### BACKGROUND

The statements in this section merely provide background information related to the present disclosure and may not constitute prior art.

For many businesses, procedures for purchasing supplies and other products can be inefficient and time-consuming. Businesses that use enterprise resource planning (ERP) systems typically must update system data constantly as to suppliers' products and prices in advance of purchasing. Ordering is typically done through inefficient sequential processes. Businesses that purchase supplies online are often required to log onto numerous websites for preferred suppliers and purchase through varying processes and systems with limited spend management and supply chain visibility.

### SUMMARY

In one implementation, the disclosure is directed to a system for providing an online marketplace for buyers and suppliers. At least one processor and memory are configured to, in response to a user of the system, establish a buying community as a portal on a network and associate the community with a plurality of buyers and a plurality of suppliers. The processor and memory are also configured to provide for cooperation, by the buyers and/or suppliers, in buy and/or supply relationships with buyers and/or suppliers associated with another buying community established on the network.

In another implementation, a method of providing an online marketplace for buyers and suppliers includes establishing a buying community as a portal on a network. The method includes providing access to the community by a plurality of buyers and a plurality of suppliers, and making available to at least some of the buyers, via the community, an offer by one of the suppliers to supply a plurality of items. The offer specifies a time period within which a buyer may submit one or more bids for one or more of the items. The offer proposes one or more buyer discounts based on buyer bidding within the time period. The method includes receiving, via the community, one or more bids from one or more of the buyers within the time period. Based on the received bid(s), the proposed buyer discount(s) are applied to at least one of the received bid(s).

In yet another implementation, the disclosure is directed to a system for providing an online marketplace for buyers and suppliers. At least one processor and memory are configured to, upon request by a user of the system, establish a buying community as a portal on a network. Based on one or more categories of items that may be supplied to buyers via the community, the processor and memory associate one or more buyer member groups with one or more suppliers via the community. Upon request by at least one of the suppliers, an offer by the supplier(s) is made available via the community to supply a plurality of items to at least some of the buyer member groups associated with the supplier(s). Bids received from the least some of the buyer member groups via the community for the items are aggregated.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagram of a system for providing an online marketplace for buyers and suppliers in accordance with one implementation of the disclosure;

FIG. 2 is a diagram of a trading network model in accordance with one implementation of the disclosure;

FIGS. 3A and 3B are screenshots of a bidding progress tracking display in accordance with one implementation of the disclosure; and

FIG. 4 is a flow diagram of a system-performed method for processing bidding in response to a supplier's offer in accordance with one implementation of the disclosure.

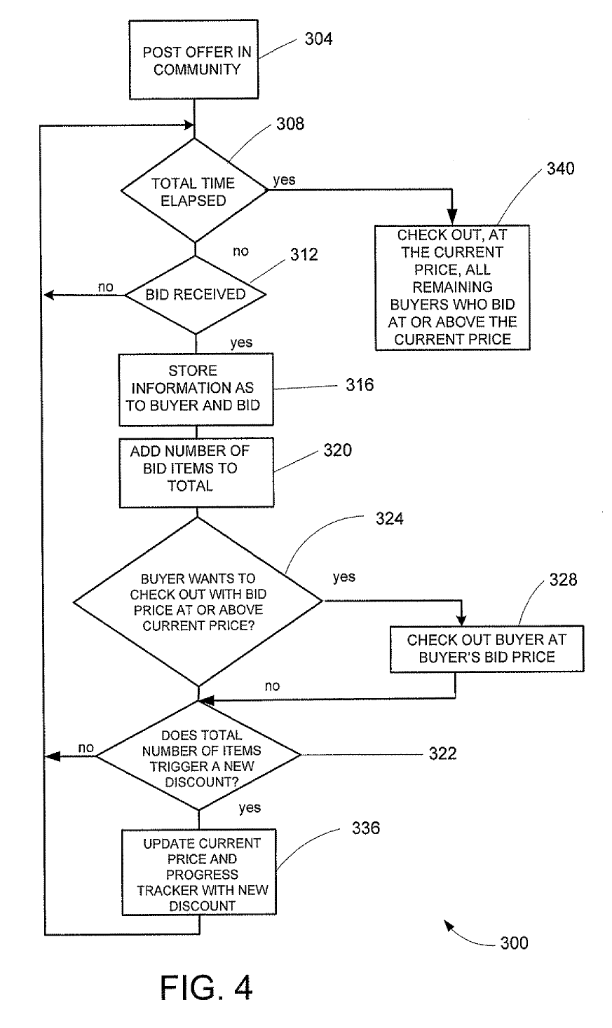

### DETAILED DESCRIPTION

The following description is merely exemplary in nature and is not intended to limit the present disclosure, application, or uses.

In various implementations of the disclosure, a system is provided whereby businesses may trade with their suppliers over an online trading network. A business may use the system to create a virtual “buying community” as a portal on the Internet or other network. The business can associate its suppliers with its buyers via the community. A supplier may use the system to create a “storefront” accessible by users of the system and may sell to one or more “buying communities” from a single “storefront”.

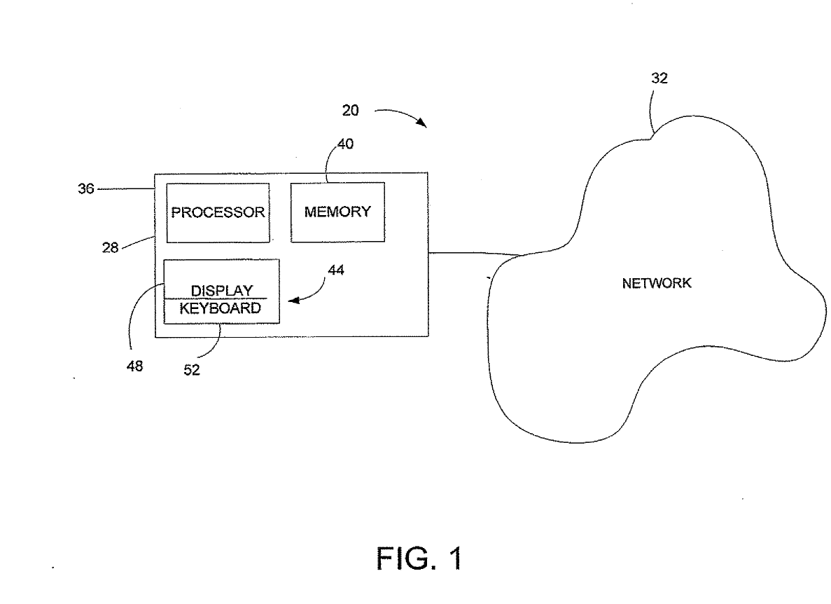

One exemplary implementation of a system for providing an online marketplace for buyers and suppliers is indicated generally in FIG. 1 by reference number 20. The system 20 includes at least one computer 28 in communication with a communications network 32. The computer 28 has a processor 36 and memory 40. The computer 28 has access to and/or may be a server providing a gateway to the network 32, which may be, e.g., the Internet. The computer 28 may include a user interface 44 having, for example, a display 48 and keyboard 52. It should be easily understood by those knowledgeable in the art that there are many different numbers and/or configurations of computers, processors, microprocessors, microcomputers, memories, interfaces, input devices and/or output devices, etc., that could be used to provide the functionalities described in this disclosure. For example, software providing at least some functionality of the system 20 could be distributed to and executed on one or more computer of a user of the system 20. It should be noted further that implementations are contemplated in connection with other or additional networks, including but not limited to extranets and intranets.

The computer 28, in response to a user of the system 20, may establish a buying community as a portal on the network 32 and associate the community with a plurality of buyers and a plurality of suppliers. As further described below, the computer 28 also may provide for cooperation, by the buyers and/or suppliers, in buy and/or supply relationships with other buyers and/or suppliers. The other buyers and/or suppliers may be associated, for example, with another buying community established as a portal on the network 32 by the computer 28.

Businesses and/or organizations may use the system 20 to make purchases through buying communities. In order to establish a business as a “buying community owner” in the system 20, a user of the system may create a virtual Internet buying community portal for the business. When the portal has been created, the user, e.g., an administrator for the buying community, may use an online wizard to select and associate one or more suppliers with one or more buyers for the business through the community. Buyers may be, e.g., selected employees of the business who have authority to enter into purchase transactions.

An administrator or other user of the system 20 may use an online wizard to issue an email invitation to suppliers and/or buyers to join a buying community. A supplier who receives an invitation may follow a wizard to setup a “storefront”, further described below, that is automatically associated with, and eligible to sell to buyers through, the buying community. The supplier then may upload one or more catalogs to the system 20 for access, e.g., by buyers of the community.

A buyer who receives an invitation may follow a wizard to join the community and is put into an appropriate member group for the community. The buyer is immediately eligible to buy from preferred suppliers, for example, at rates that may have been pre-negotiated by the community. The buyer may also collaborate on volumetric promotions as further described below.

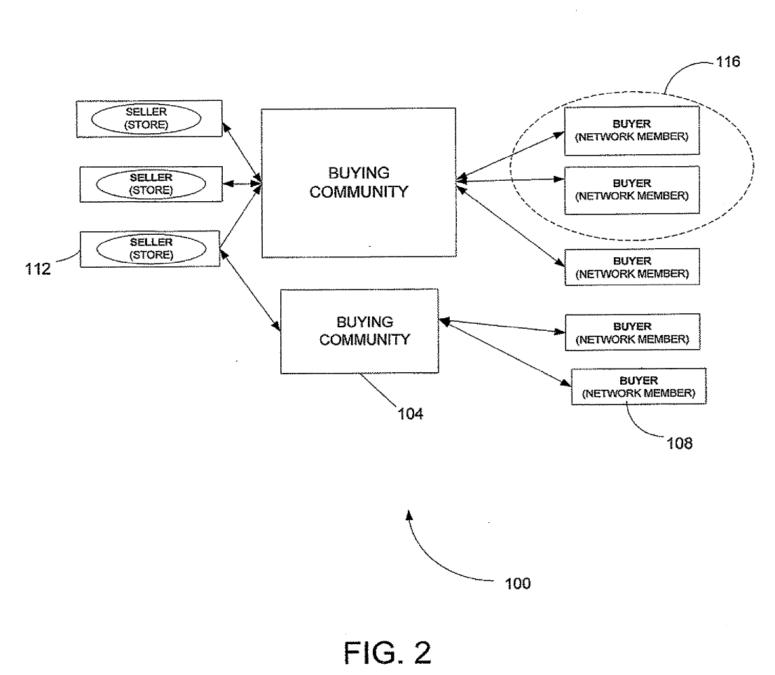

In various implementations, a trading network may be provided as indicated conceptually by a network model indicated generally in FIG. 2 by reference number 100. It should be noted generally that trading entities in the network model 100 are allowed to form relationships with other trading entities in the network 100. A trading entity may have a role, e.g., of “community owner”, “buyer” and/or “seller”.

As shown in the model 100, a plurality of buying communities 104 are available as network portals to a plurality of buyers 108 and suppliers 112. A buyer 108 may be, e.g., a business employee who is authorized to make purchases from at least some of the suppliers 112. Employee members 108 may be organized into groups 116 based, e.g., on categories of items that a group 116 is authorized to purchase. Accordingly, a member group 116 may have access via a community 104 only to those suppliers 112 that supply the particular categories of items that the group 116 is authorized to purchase.

A supplier 112 may be made eligible to sell to a buyer 108 by virtue of their mutual association through a community 104. A supplier 112 is available on the network 100 as an online “storefront” established by the supplier. A supplier 112 may sell to buyers 108 via one or more buying community 104 portals from the same storefront. A member 108 of a buying community 104 may log on to the community portal, e.g., to purchase directly from one or more catalogs maintained online by suppliers 112 who are eligible to sell to that buyer 108. Buyers 108 may also request quotes from eligible suppliers 112 for specific items and may submit service requests to suppliers 112. It should be noted that the term “item” may be used in this disclosure and the claims to refer to a good and/or a service. It should be noted further that unless otherwise indicated, terms such as “purchase”, “buy”, “buyer”, “sell”, “supplier” and “supply” may be interpreted broadly in the disclosure and claims. For example, the foregoing terms could be used to indicate other or additional types of agreements or transactions, including but not limited to leases, loans, and/or rentals.

In various trading network configurations, various kinds of B2B (business-to-business) functionality may be performed, for example, uploading of catalogs, integration with supplier web sites to bring back orders, integration to buyer and supplier ERP systems for automation, RFQ (request-for-quotes) functionality and e-invoicing functionality for three-way invoice matching. In some implementations, buyers for a business may go through a requisition approval process with integration to the business' back-end ERP systems.

In some implementations, business buyers 108 may be restricted by the network 100 to buying within their business buying community 104 and may not be allowed to join other buying communities 104. In some implementations in which a public buying community is established, an individual not previously affiliated with a buying community may request online to be allowed to participate in a public community. An administrator for the public community may evaluate the prospective buyer, e.g., by asking registration questions, and put the buyer into an appropriate buyer member group for the community (which may dictate which suppliers the buyer sees).

The network 100 makes it possible for buyers 108 and suppliers 112 to collaborate across organizational boundaries. Thus in some implementations, buyers of two member groups 116 in a buying community 104 may aggregate their purchases from one or more suppliers 112 and thereby may achieve economies of scale. Additionally or alternatively, buyers 108 of two or more buying communities 104 may be able to buy together from one or more suppliers.

A supplier 112 can target its market segments separately or simultaneously from within the same platform over the network 32 (shown in FIG. 1), e.g., by positioning products and/or services with tailored catalogs from its branded e-storefront. For example, suppliers 112 may position different product promotions or product mixes for each of their specified customer segments. Only members of that customer segment, e.g., buyers 108 connected through a given community portal or portals, would have visibility of the products and promotions offered by that supplier 112. In such manner, a decentralized purchasing model can appear centralized by virtue of buyers 108 being included in coordinated virtual “buying communities”. In the network 100, it is possible to aggregate decentralized orders from disparate fragmented buyers 108 and to submit a consolidated order to one or more suppliers 112. Businesses thus are allowed to collaborate across organizational boundaries to achieve economies of scale.

In the network 100, buyers 108 can aggregate their spending across organizational boundaries to achieve optimal price breaks offered within published time periods by participating suppliers 112. For example, within a time period (e.g. two weeks) in which a supplier's product is listed via a community portal 104, buyers 108 may “bid” for the product at their elected volumes and prices. When buyers 108 throughout the community 104 submit their bids and contribute to overall volume or value of the bidding, volume and/or price breaks can be achieved as a group.

Such “bid together” events may be offered by a supplier, e.g., by means of an online catalog of products for which volumetric price breaks may be obtained. Such events may be offered to one or more member groups 116 within or across communities 104. Buyers 108 within eligible member groups can commit to purchases of products within the respective catalogs that build a volume commitment to suppliers that justifies discounts. A buyer 108 within such an event may achieve the lowest discount as long as (a) the buyer does not “check out” manually at an earlier price before a price drop and (b) the buyer 108 did not bid in a future price break that does not achieve enough volume to become active. When such an event expires, all bids in the current price break or higher price are automatically checked out at the current price at that time. All bids that are not eligible at this time become missed orders for the buyer.

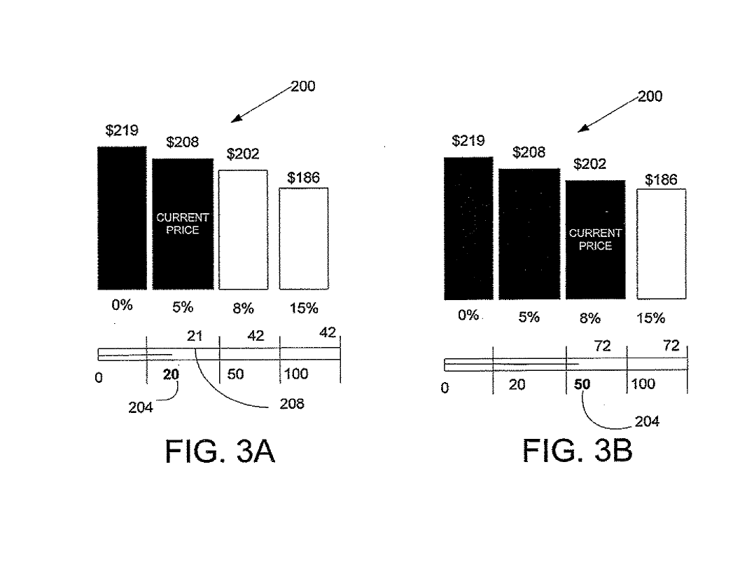

An exemplary bidding progress tracking display is indicated generally in FIGS. 3A and 3B by reference number 200. The display 200 may change over time as bids are received from buyers. In the present example, an item is offered at an original price of $219. As bids are received for numbers of the item, the current price is reduced by one or more predefined discounts. As shown in FIG. 3A, a value 204 indicating a number of items sold has reached twenty (20) and the current price has become $208, reflecting a discount of five percent (5%) off the original price. A value 208 indicates numbers of buyers bidding on the items. As shown in FIG. 3B, the number of items sold 204 has exceeded fifty (50) and the current price has become $202, reflecting a discount of eight percent (8%) off the original price. It should be noted that although the discounts indicated in FIGS. 3A and 3B are based on numbers of items, discounts could be offered based on other or additional criteria. For example, a discount could be offered based on the monetary value of items purchased.

A flow diagram of one exemplary method performed, e.g., by the system 20 to process a supplier's offer is indicated generally in FIG. 3 by reference number 300. In step 304, when a supplier submits an offer to sell an item through its storefront, the offer is posted in one or more community portals selected by the supplier. The offer may specify a supplier-selected time period during which bids from buyers will be accepted by the system 20. In step 308 the system 20 determines whether the specified time period has elapsed. If not, then in step 312 it is determined whether a bid has been received from a buyer via the community or communities in which the offer was posted. If a bid is received, the system 20 in step 316 obtains and stores information descriptive of the bid and of the buyer, including, e.g., contact and delivery details. In step 320 the system 20 adds a number of items in the bid to a total number of items for which bids were made.

A buyer may purchase item(s) at or above a price currently in effect for an item. For example, before a time period for receiving bids on an offer has expired, a buyer member may decide to purchase items at a price he/she previously bid for them. In other implementations, it may be possible for a buyer to pay a current price for item(s) before bidding has concluded. In step 324 the system 20 determines whether a request has been received from a buyer who wishes to purchase item(s) at a bid price at or above the current price for the item(s). If so, then in step 328 the buyer is “checked out” at the buyer's bid price; e.g., the buyer's payment and delivery information is sent to the appropriate supplier storefront via the appropriate community.

In step 332 it is determined whether the total number of items calculated in step 320 is sufficient to trigger a new discount. If yes, then in step 336 the current price for the item is updated to reflect the new discount and a progress tracker display 200 may be updated accordingly. Control then is returned to step 308. If in step 308 the total time for bidding has elapsed, then in step 340 all buyers remaining in the bidding process who have bid at or above the current price are checked out at the current price. In such manner, buyers who bid in excess of the final price may receive the benefit of the lower current price.

Other or additional benefits can accrue to users of various systems and methods in accordance with the disclosure. For example, users of the system 20 may consolidate supply chains by leveraging collaborative capabilities provided by the system 20. Large (e.g., collaborative) orders via a buying community can be submitted to a supplier as a single consolidated order. The suppliers then can ship the single large order to a cross-docking facility where each individual small order is split and shipped to the individual buyers within the community. This capability can greatly reduce supply chain costs for both seller and customer. In some implementations, a supplier 112 can establish its own buying community 104 and buy exclusively from other suppliers 112, collaborate with other buying communities 104, and so on. In such manner, an entire value chain could be captured through networks and segmentation.

Traditionally suppliers have maintained their product catalogs locally and provided the information to buyers who then have duplicated these product catalogs within their own local systems. Both parties then have had to keep each repository current. Using various implementations of the disclosure can reduce the need for maintenance of master data by enabling online supplier-maintained catalogs. Each supplier can upload its catalogs to an online repository and make the catalogs available to buyers from the repository. Buyers may then purchase directly from a supplier catalog online without the need to hold any information locally.

The foregoing system and methods can be used to provide an independent, securely hosted marketplace in which businesses can trade with their suppliers efficiently and in a cost-effective manner. A buying community can be established across a company or organization to enable its members to purchase exclusively from preferred suppliers. Buyers can use a portal that provides integrated buying capability while at the same time providing segmentation of buyers according to the types of goods and/or services that buyers seek to purchase. A community can be integrated with a business' approval processes and purchases can be coordinated with backend systems of the business. For purchases made via the community, reports can be generated to describe spending by category, supplier, department and/or buyer.

Suppliers can maintain branded online “e-stores” that can provide catalogs and advertisements to prospective buyers. Suppliers also can target promotions to specific customer groups for specific products and/or services at specific pricing. A community can be integrated with a suppliers catalogs, pricing, inventory and sales, which can be coordinated with backend systems of the supplier. For sales made via the community, reports can be generated to describe sales by category, customer group and/or customer.

Whereas procurement staff members previously had to log in and out of multiple supplier portals to complete their procurement requirements, various implementations of the foregoing system and methods allow buyers to purchase from multiple suppliers from within one integrated independent procurement solution. This can drastically reduce the efforts of procurement staff, since they can have access to all their preferred suppliers in one place rather than having to deal with each supplier on a different basis. It should be noted that having all suppliers on the same platform also enables a buyer to “check-out” across a plurality of suppliers in a single action.

What is claimed is:

1. A system for providing an online marketplace for buyers and suppliers, the system comprising at least one processor and memory configured to:
in response to a user of the system, establish a buying community as a portal on a network and associate the community with a plurality of buyers and a plurality of suppliers; and
provide for cooperation, by the buyers and/or suppliers, in buy and/or supply relationships with buyers and/or suppliers associated with another buying community established on the network.

2. The system of claim 1, the at least one processor and memory configured to:
make available to the buyers, via the communities, offers by the suppliers to supply items;
receive bids for at least some of the items via more than one of the communities from at least some of the buyers; and
aggregate the received bids to consolidate an order to one of the suppliers.

3. The system of claim 1, the at least one processor and memory configured to:
make available to the buyers, via the communities, offers by the suppliers to supply items;
receive, from one of the buyers, bids directed to more than one supplier; and
aggregate the bids received from the one of the buyers to provide a single checkout for the one of the buyers.

4. The system of claim 1, the at least one processor and memory configured to include at least some of the buyers having access to a given community in a member group for which purchases via the given community are limited to one or more predefined types of items.

5. The system of claim 4, the at least one processor and memory configured to make available an offer by a given supplier to supply at least some of the predefined types of items to the member group.

6. The system of claim 1, the at least one processor and memory configured to provide access by one of the suppliers via a single storefront to a plurality of buying communities on the network.

7. The system of claim 1, the at least one processor and memory configured to establish the buying community in response to a supplier.

8. A method of providing an online marketplace for buyers and suppliers comprising:
establishing a buying community as a portal on a network;
providing access to the community by a plurality of buyers and a plurality of suppliers;
making available to at least some of the buyers, via the community, an offer by one of the suppliers to supply a plurality of items, the offer specifying a time period within which a buyer may submit one or more bids for one or more of the items, the offer proposing one or more buyer discounts based on buyer bidding within the time period;
receiving, via the community, one or more bids from one or more of the buyers within the time period; and
based on the one or more received bids, applying the one or more proposed buyer discounts to at least one of the one or more received bids.

9. The method of claim 8, the offer proposing a buyer discount based on a total number of items for which bidding is submitted.

10. The method of claim 8, the offer proposing a buyer discount based on a total amount of money for which bidding is submitted.

11. The method of claim 8, further comprising using a proposed buyer discount to update a current item price at least once within the time period.

12. The method of claim 8, wherein the community is established in response to a request by one of the buyers to establish the community.

13. The method of claim 8, wherein the plurality of items include more than one type of item.

14. The method of claim 8, further comprising:
making the offer available to a second plurality of buyers, via a second community;
receiving, via the second community, at least one bid within the time period; and
aggregating the at least one bid with the one or more received bids to apply the one or more discounts.

15. The method of claim 8, wherein one of the buyers is a supplier to a second buying community.

16. A system for providing an online marketplace for buyers and suppliers, the system comprising at least one processor and memory configured to:
upon request by a user of the system, establish a buying community as a portal on a network;
based on one or more categories of items that may be supplied to buyers via the community, associate one or more buyer member groups with one or more suppliers via the community;
upon request by at least one of the suppliers, make available via the community an offer by the at least one supplier to supply a plurality of items to at least some of the buyer member groups associated with the supplier; and
aggregate bids received from the least some of the buyer member groups via the community for the items.

17. The system of claim 16, wherein the offer specifies a time period within which a buyer may submit one or more bids for one or more of the items, the offer proposing one or more buyer discounts based on buyer bidding within the time period;
the system further configured to receive one or more bids from one or more of the buyer group members within the time period, and, based on the one or more received bids, associate the one or more proposed buyer discounts with at least one of the one or more received bids.

18. The system of claim 16, further configured to allow a buyer group member to submit bids to a plurality of the suppliers via the community for a plurality of items.

19. The system of claim 16, wherein the one of the suppliers uses a second buying community to obtain one or more of the items.
